(19) United States
(12) Patent Application Publication
(10) Pub. No.: US 2020/0001633 A1
(43) Pub. Date: Jan. 2, 2020

(54) DANCER SUSPENSION ASSEMBLY FOR A ROLL-TO-ROLL PRINTER

(71) Applicant: Océ Holding B.V., Venlo (NL)

(72) Inventors: Marcus H.G.W. HEES, Venlo (NL); Patrick VINK, Venlo (NL)

(73) Assignee: Océ Holding B.V., Venlo (NL)

(21) Appl. No.: 16/450,454

(22) Filed: Jun. 24, 2019

(30) Foreign Application Priority Data
Jul. 2, 2018 (EP) 18181225.6

(51) Int. Cl. B41J 15/04; B65H 23/04

(52) U.S. Cl. CPC B41J 15/048; B65H 2515/30; B65H 23/048

(57) ABSTRACT

A dancer suspension assembly for use in a roll-to-roll printing system, which assembly comprises a wire element connectable to a dancer of the printing system, which wire element is connected to actuator via a spring element, which actuator is configured to control a spring force exerted by the spring element on the wire element, and a pulley assembly around which the wire element runs. The spring element allows the operator to adjust the spring force and to apply said spring force to the dancer at any position of the dancer. Both the web tension and the dancer position can be controlled in a simple manner.

### FIELD OF THE INVENTION

The present invention generally pertains to a web printing system and a dancer suspension assembly for use in such a web printing system as well as to a method for transporting a web through such a web printing system.

### BACKGROUND ART

A web printing system comprises an input roller and an output roller, wherein a web is unwound from the input roller and transported over a print surface towards the output roller. Above the print surface a print head carriage is provided which carriage is moveable in a width direction of the web for swathwise depositing an image on the web. The web is generally transported stepwise in between the printing of consecutive swaths, though continuous web movement while swathwise printing could be imaged for certain applications. The width of the applied webs is generally large, 2 meters or more. In order to avoid print artifacts consecutive swaths need to be aligned on the web. The accuracy of aligning swaths is in part determined by accuracy by which the web is transported. A driving roller in contact with the web generally determines the displacement of the web across the print surface. Such driving rollers are generally relatively large and/or heavy. More accurate control of the rotation of the driving roller requires expensive systems (motors, sensors, brakes, etc.) to precisely determine and control the rotation of the driving roller. A consecutive swath may further be aligned with a previous swath by adjusting the printing of the consecutive swath, for example by digitally adjusting the swath data such that the swath when printed is translated and/or rotated with respect to the width direction. Such digital correction requires accurate sensing of the web's orientation and position as well as a large computer processing capacity to adjust the swath in a sufficiently short time without delaying the print process.

### SUMMARY OF THE INVENTION

It is an object of the present invention to provide a simple and versatile web printing system which yields an improved image quality.

In a first aspect, the present invention provides a web printing system according to claim 1. The web printing system comprises:
a dancer positioned along a transport path extending from an input roller for holding a first media roll to an output roller for holding a second media roll;
an actuator for moving the dancer with respect to a frame of the printing system, wherein the dancer is connected to the actuator via a spring element.

The dancer, for example in the form of a roller, is during printing operations in contact with the web. The dancer is thereby able to exert a force on the web by means of which the dancer may adjust the tension the web. To increase the accuracy of the media transport the position of the dancer should be relatively stable. Since the dancer is connected to the actuator via the spring element, the dancer is not rigidly fixed to the frame of the printing system. By adjusting the spring force of the spring element, preferably by adjusting the length of the spring element, the force exerted by the dancer on the web can be controlled to a desired value at any position of the dancer. Thereby, the tension in the web can be set to a desired value in correspondence with the media type of the applied web medium while maintaining the dancer at a desired operational position. This allows for the application of a wide variety of print media as well as high quality printing due to accurate control of the web tension at any desired position of the dancer. Thereby, the object of the present invention has been achieved.

In an embodiment, the actuator is configured for controlling a spring force exerted by the spring element on the dancer. By means of a roller actuator for rotation of the input, output, or stepping roller the position of the dancer can be controlled and set. As such the spring force can be set and varied with respect to the position of the dancer and/or vice versa. As such different values for the spring force can be set for each position of the dancer. This increases the available print media range of the printing system. Preferably, the actuator is configured for adjusting a length of the spring element, thereby determining a spring force and a tension in a web in contact with the dancer. The spring force is proportional to the length of the spring element, which length can be varied by stretching or contracting the spring element. Controlling the length of the spring element provides a simple and reliable manner for determining the force exerted by the dancer on the web.

In another embodiment, the printing system further comprises a spring force sensor for determining a spring force generated by the spring element. By determining the spring force the actuator can be controlled to set the spring length to the desired value for generating a spring force to achieve the desired tension in the web. Preferably, the spring force sensor comprises a spring length sensor. The spring length sensor in one embodiment determines the spring length by sensing the displacement of an element connected to an end of the spring element. The spring length sensor may thereby determine whether the spring length is within a predetermined range.

In a further embodiment, the dancer is connected to the spring element via a flexible wire element. The flexible wire element is tensioned by the spring force and transmits this force to the dancer. Using a flexible wire element allows the dancer suspension assembly to be substantially positioned within an inner volume of the printing system defined by the input roller, output roller, and the print surface. Thereby, the printing system remains compact.

In an embodiment, the printing system according to the present invention further comprises a pulley assembly, wherein the wire element extends substantially perpendicular to a length of the dancer away from the dancer and curves around the pulley assembly towards the actuator. The pulley system directs the wire element into the inner volume between the input and output rollers. The pulley assembly provides a low friction and simple solution for directing the wire element.

In another embodiment, the wire element extends from a first to a second side of the dancer via the pulley assembly. Both ends of the dancer are connected to or engaged by the same, single wire element. Using a single wire element in the pulley assembly allows for the use of a single actuator to control the spring force on both sides of the dancer. Preferably, the actuator connects to an actuator pulley of the pulley assembly, which actuator pulley is moveable with respect to the frame to adjust the spring force. The actuator is for example a linear actuator configured to move the actuator pulley, such that the spring length of the spring element is adjusted.

In an embodiment, when viewed from above, the pulley assembly is positioned between the input roller and the output roller. The pulley assembly is positioned within the inner volume of the printing system, thereby keeping overall dimensions of the printing system compact and improving the safety by hiding moveable components away from the operator.

In an embodiment, the printing system further comprises a roller actuator configured to adjust the position of the dancer, such that an angle by which dancer curves the web is maintained as a substantially straight angle as a diameter of a media roll on the input roller decreases during printing operations. The web is fed from the input roller towards the dancer in a first, preferably horizontal, direction and is curved around the dancer to a second, preferably vertical, direction. In an embodiment the second direction extends upwards from the dancer towards the turn element. As the diameter of the media roll decreases the position of the dancer requires adjusting to keep the angle between the first and second directions substantially constant. Said angle is preferably around 90° to decouple forces in the first direction from acting on a section of the web on the print surface.

In a further embodiment, the printing system comprises a controller configured to determine a spring force parameter from the spring force sensors, and wherein the controller is further configured to prevent printing when the spring force parameter is determined to lie outside a predetermined working range. The working range is preferably defined by a lower and upper spring force limit. The controller determines whether the spring force parameter, which may be a value of the spring force or a position or length parameter of the spring element, is positioned between the lower and upper spring force limits. If positioned within the working range the spring force is sufficient to achieve the desired tension in the web. Outside said working range the spring force would result in too low or too great tension in the web, negatively affecting the accuracy of the web transport. Preferably, the controller is configured to control the actuator to adjust the spring element, specifically its spring force and/or length, to maintain the determined spring force parameter within the working range.

In another embodiment, the printing system according to the present invention further comprises a controller storing a media catalogue comprising a plurality of spring force settings for a plurality of media types, wherein the controller is configured to control the actuator to set a spring force of the spring element to the spring force setting in accordance with a media type selected from the media catalogue. Web media properties such as elasticity, tear resistance, flexibility may vary between different media types such as papers, foils, textiles, banners, etc. The controller stores on its memory a media catalogue comprising a plurality of predefined media types. For most or each media type a corresponding spring force setting is defined and stored on the memory. The spring force setting may comprise a spring force value or working range. During operation the controller controls the actuator to maintain the spring force within said working range by monitoring the spring force via the spring force sensor.

In another aspect, the present invention provides a dancer suspension assembly for use in a printing system according to the present invention. The dancer suspension assembly comprises:
a wire element connectable to a dancer of the printing system, which wire element is connected to an actuator via a spring element, which actuator is configured to control a spring force exerted by the spring element on the wire element; and
a pulley assembly around which the wire element runs.

The dancer suspension assembly may be configured as described in any of the above described embodiments.

In a further aspect, the present invention provides for a method for transporting a web in a web printing system, the method comprising the steps:
a dancer pressing against the web to tension the web, wherein a spring element pulls on the dancer via a wire element; and
an actuator pulling on the spring element for a spring force exerted by the spring element on the dancer.

The web extends along its transport path from the input roller to the output roller. The web preferably curves around the dancer upwards towards the turn element. Since the dancer is connected to the actuator via the spring element, the dancer even when its position is constant, is able to exert a force on the web. As such, the method allows for control of the dancer's position and the web tension in a simple manner.

In an embodiment, the method according to the present invention further comprises the step of:
a roller actuator adjusting the position of the dancer such that an angle over which angle the web curves around the dancer is substantially constant as the web is unwound from a media roll on the input roller. By keeping the angle constant a decoupling of forces is achieved which results in improved image quality.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1A is a schematic perspective view of a printing system;

FIG. 1B is a schematic perspective view of an inkjet printing assembly the printing system in FIG. 1A;

FIG. 2 is a schematic perspective view of an embodiment of a printing system according to the present invention;

FIG. 3 is a schematic front view of an embodiment of a dancer suspension assembly according to the present invention.

### DETAILED DESCRIPTION OF THE DRAWINGS

The present invention will now be described with reference to the accompanying drawings, wherein the same reference numerals have been used to identify the same or similar elements throughout the several views.

### Printing System

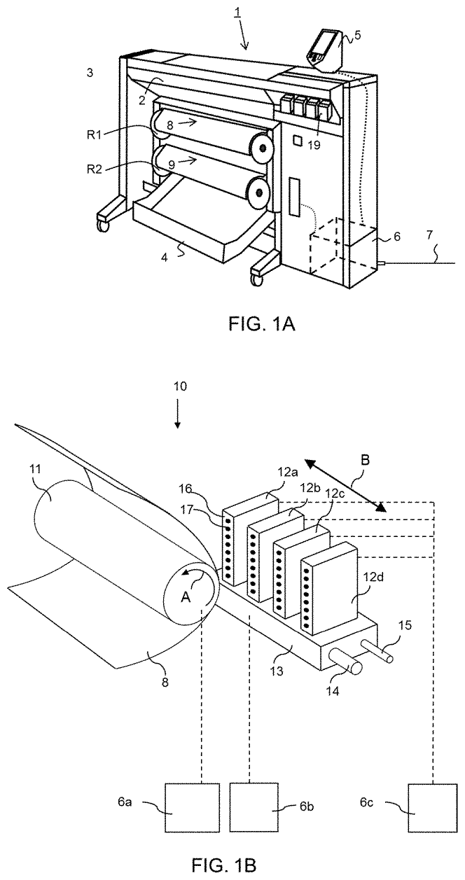

FIG. 1A shows an image forming apparatus 1, wherein printing is achieved using a wide format inkjet printer. The wide-format image forming apparatus 1 comprises a housing 2 holding the printing assembly 10. The image forming apparatus 1 also comprises at least one media input unit 3 for storing one or more media 8, 9 in the form of a wound-up roll of web medium. The media 8, 9 are supplied by a roll 8, 9. The roll 8 is supported on the roll support R1, while the roll 9 is supported on the roll support R2. A transport path extends from the media input unit 3 along the printing assembly 10 to a receiving unit 4 to collect the medium 8, 9 after printing. A storage unit 19 for marking material is provided to hold marking materials. Each marking material for use in the printing assembly 10 is stored in one of a plurality of containers 19 arranged in fluid connection with the respective print heads for supplying marking material to said print heads to print an image on the medium 8, 9. The receiving unit 4 may comprise a take-up roller for winding up the printed medium 8, 9 or a receiving tray for supporting sheets of printed medium 8, 9. Optionally, the receiving unit 4 may comprise processing means for processing the medium 8, 9 after printing, e.g. a post-treatment device such as a coater, a folder or a puncher. The wide-format image forming apparatus 1 furthermore comprises a user interface 5 for receiving print jobs and optionally for manipulating print jobs. The local user interface unit 5 is integrated to the print engine and may comprise a display unit and a control panel. Alternatively, the control panel may be integrated in the display unit, for example in the form of a touch-screen control panel. The local user interface unit 5 is connected to a control unit 6 connected to the image forming apparatus 1. The control unit 6, for example a computer, comprises a processor adapted to issue commands to the image forming apparatus 1, for example for controlling the print process. The image forming apparatus 1 may optionally be connected to a network N. The connection to the network N is diagrammatically shown in the form of a cable 7, but nevertheless, the connection could be wireless. The image forming apparatus 1 may receive printing jobs via the network N. Further, optionally, the control unit 6 of the image forming apparatus 1 may be provided with a USB port, so printing jobs may be sent to the image forming apparatus 1 via this USB port.

### Printing Assembly

FIG. 1B shows an ink jet printing assembly 10. The ink jet printing assembly 10 comprises a medium support surface to support the medium 8, 9 during printing. The medium support surface in FIG. 1B is provided on a platen 11 in the form of a drum rotatable in direction A, but may, alternatively, be a flat support surface. The medium support surface is preferably provided with suction holes for at least temporarily holding the medium 8, 9 in a fixed position with respect to the medium support surface. The ink jet printing assembly 10 comprises print heads 12a-12d, mounted on a scanning print carriage 13, or alternatively as a stationary page-wide array. The scanning print carriage 13 is guided by suitable guides 14, 15 to move in reciprocation in the main scanning direction B. Each print head 12a-12d comprises an orifice surface 16, which orifice surface 16 is provided with at least one orifice 17. The print heads 12a-12d are configured to eject droplets of marking material onto the medium 8, 9. The medium support surface, the carriage 13 and the print heads 12a-12d are controlled by suitable controlling means 6a, 6b and 6c, respectively.

The medium 8, 9 is supplied in web form and may be composed of e.g. paper, cardboard, label stock, coated paper, plastic or textile. The medium 8, 9 is moved in the sub-scanning direction A by the platen 11 along four print heads 4a-4d provided with a fluid marking material.

A scanning print carriage 13 carries the four print heads 12a-12d and may be moved in reciprocation in the main scanning direction B parallel to the medium support surface, such as to enable scanning of the medium 8, 9 in the main scanning direction B. Any number of print heads may be employed. Preferably, at least one print head 12a-12d per color of marking material is placed on the scanning print carriage 13, for example one for print head 12a-12d for each of the applied colors, usually black, cyan, magenta and yellow is present. Often, in a full-color printer, black marking material is used more frequently in comparison to differently colored marking material. Therefore, more print heads 12a-12d containing black marking material may be provided on the scanning print carriage 13 compared to print heads 12a-12d containing marking material in any of the other colors. Alternatively, the print head 12a-12d containing black marking material may be larger than any of the print heads 12a-12d, containing a differently colored marking material.

The carriage 13 is guided by guides 14, 15 in the form of guide rails or rods 14, 15, as depicted in FIG. 1B. The carriage 13 may be driven along the guides 14, 15 by a suitable driving actuator (not shown). An alternative is to move the medium 8, 9 in the main scanning direction B.

### Print Heads

Each print head 12a-12d comprises an orifice surface 16 having at least one orifice 17, in fluid communication with a pressure chamber containing fluid marking material provided in the print head 12a-12d. On the orifice surface 16, a number of orifices 17 is arranged in a single linear array parallel to the sub-scanning direction A. Eight orifices 17 per print head 12a-12d are depicted in FIG. 1B, however obviously in a practical embodiment at least several hundreds of orifices 17 may be provided per print head 12a-12d, optionally arranged in multiple arrays. As depicted in FIG. 1B, the respective print heads 12a-12d are placed parallel to each other such that corresponding orifices 17 of the respective print heads 12a-12d are positioned in-line in the main scanning direction B. This means that a line of image dots in the main scanning direction B may be formed by selectively activating up to four orifices 17, each of them being part of a different print head 12a-12d. This parallel positioning of the print heads 12a-12d with corresponding in-line placement of the orifices 17 is advantageous to increase productivity and/or improve print quality. Alternatively multiple print heads 12a-12d may be placed on the print carriage adjacent to each other such that the orifices 17 of the respective print heads 12a-12d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 17.

Upon ejection of the marking material, some marking material may be spilled and stay on the orifice surface 16 of the print head 12a-12d. The ink present on the orifice surface 16, may negatively influence the ejection of droplets and the placement of these droplets on the medium 8, 9. Therefore, it may be advantageous to remove excess of ink from the orifice surface 16. The excess of ink may be removed for example by wiping with a wiper and/or by application of a suitable anti-wetting property of the surface, e.g. provided by a coating.

### Dancer Suspension Assembly

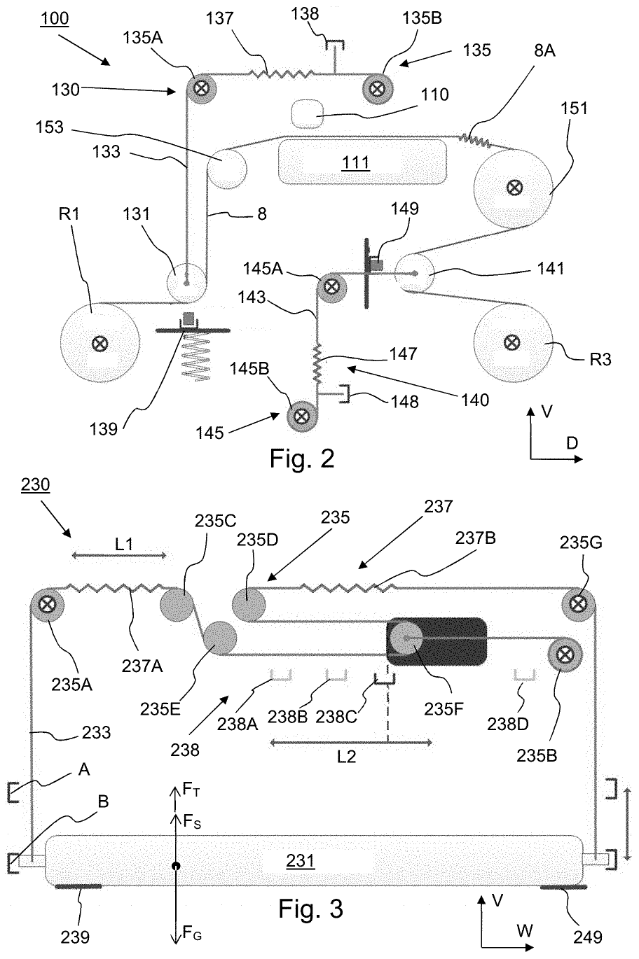

FIG. 2 discloses a printing system 100 according to the present invention. It will be appreciated that any features of the printing system 1 may be incorporated in the printing system 100 in FIG. 2. The printing system 100 is a roll-to-roll printing system 100, wherein a web 8 is unwound from a first media roll on an input roller R1 to a second media roll on an output roller R3. The web 8 is unwound from the input roller R1 in substantially the horizontal direction H towards a first dancer 131. The first dancer 131 is a roller 131 rotatable around its central axis and moveable in substantially the vertical direction V. Preferably, is dancer 131 is controlled to adjust its vertical position as the web 8 is unwound from the input roller R1, such that the web 8 leaves the input roller R1 in substantially the horizontal direction H regardless amount of media remaining on the input roller R1. This positional adjustment may be done by applying an appropriate force by means of a roller actuator for driving the input roller R1. The first dancer 131 during operation is adjusted in correspondence with the decreasing diameter of the media roll on the input roller R1 to keep the web horizontal between the input roller R1 and the first dancer 131. The web 8 then curves around the first dancer 131 towards the substantially vertical direction towards the turn element 153. The web 8 thus curves around the first dancer 131 over a substantially straight angle (i.e. circa) 90°. By adjusting the vertical position of the first dancer 131, this angle is kept constant while the diameter of the media roll on the input roller R1 decreases. Maintaining a substantially straight angle allows for force decoupling of forces acting on the web 8 on the input roller side of the first 131 dancer from the web 8 on the print surface side of the first dancer 131. This increases the inaccuracy of the step-wise displacement of the web 8 as well as its positional stability in between displacement steps. Preferably, the first dancer 131 is positioned such that the web 8 extends substantially horizontally between the input roller R1 and the first dancer 131. The weight of wide media rolls (e.g. over meters wide) causes the middle section of the input roller 131 to sag. Due to said sagging the input roller 131 is in practice not perfectly straight, but comprises a parabolic curvature with a lowest point in the middle of the input roller 131 (if the media roll is positioned centrally on the input roller 131). The media roll during unwinding is not fully cylinder symmetric, which results in inaccuracy in the positioning of the web 8. By allowing the web 8 to unwind from the top of the media roll in a substantially horizontal direction D towards the first dancer 131, the effect of the sagging are removed or significantly reduced. The web 8 between the input roller R1 and the first dancer 131 comprises a substantially homogeneous tension in both the length and width directions of the web 8. In consequence, the media positioning accuracy is improved.

The turn element 153 curves the web 8 from its vertical orientation towards the substantially horizontal print surface 111. The turn element 153 is preferably a stationary turn bar 153 provided with a low friction surface such that the web 8 slides over said surface with minimum resistance. The print surface 111 is provided with suction holes (not shown) through which an underpressure in applied to the web 8 to adhere the web to the print surface 111. Thereby flatness of the web 8 on the print surface 111 is improved. Above the print surface 111 the inkjet printing assembly 110 is provided. As explained previously in FIG. 1B, the inkjet printing assembly 110 comprises a print head carriage moveable in a width direction over the web 8 for swath-wise printing an image on the web 8.

Downstream of the print surface 111 a stepping roller 151 is provided. The stepping roller 151, for example a capstan roller, is provided with a high friction surface (such as a rubber surface) for engaging the web 8. The stepping roller 151 is driven by an actuator (not shown) configured to move the stepping roller 151 over a predetermined angle to move the web 8 a predetermined distance over the print surface 111. The low friction of the stationary turn element 153 combined with the force decoupling of the 90° turn by means of the first dancer 131 improve the accuracy by which the web 8 can be stepwise moved. The rotation of the stepping roller 151 determines the displacement of the web 8 over the print surface 111. For illustrative purposes the elasticity 8A or stiffness 8A has been visually indicated as a spring 8A. Rotating the stepping roller 151 affects the tension in the web 8 upstream of the stepping roller 151. To accurately displace the web 8 with respect to the printing assembly 110 accurate control over the web tension is required. It is further noted that the stiffness 8A may vary greatly between different media types, such as paper, foil, textile, etc.

Downstream of the stepping roller 151, the web 8 curves around the second dancer 141. The second dancer 141 is moveable in substantially the horizontal direction H. From the second dancer 141 the web 8 extends to the output roller R3 which winds the web 8 into a media roll.

The first and second dancers 131, 141 are configured to locally tension the web 8. The first dancer 131 tensions the web between the input roller R1 and the turn element 133. The second dancer 141 tensions the web 8 between the stepping roller 151 and the output roller R3. Each dancer 131, 141 is supported by its respective dancer suspension assembly 130, 140. Both dancers 131, 141 are connected to an actuator 135B, 145B via a wire element 133, 143. A spring element 137, 147 is provided along the wire element 133, 143. The motor or actuator 135B, 145B pulls on the respective dancer 131, 141 via the respective spring element 137, 147. The spring element 137, 147, when stationary, provides a tension force on the respective dancer 131, 141 even when the dancer 131, 141 is stationary. As such the tension in the web 8 can be controlled to a desired value.

Preferably, the printing system 100 includes a position sensor (not shown) to determine the position of each dancer 131, 141. The position sensor may be an encoder provided in the respective dancer support pulley 135A, 145A, as the rotation of the dancer support pulley 135A, 145A provides a measure for the displacement of the dancer 131, 141. The displacement of each dancer 131, 141 is preferably limited to linear movement. In an advantageous embodiment, the dancers 131, 141 are suspended on either end by a rod mechanism. The rod mechanism is in an exemplary embodiment a four rod mechanism, wherein the dancer 131, 141 is mounted on a central one of the four rods. While the outer two rods are preferably straight, the central rod preferably comprises a curvature such that the dancer 131, 141 is restricted to substantially linear movement. The rod mechanism provides a low friction solution for limiting the movement of the dancer 131, 141. Additionally, contact sensors 139, 149 may be provided to collaborate with the position sensor. The contact sensors 139, 149 provide a fixed position with respect to the frame of the printing system 100 and transmit a signal when the dancer 131, 141 is positioned at said position. By determining the displacement from said position, e.g. by means of the encoders, the position of the dancer 131, 141 can be determined swiftly and accurately after a new web 8 has been loaded on the printing system 100.

Further, one or more spring sensors 138, 148 may be provided which spring sensors 138, 148 are configured to determine the force exerted by the spring element 137, 147.

Preferably, the spring sensor 138, 148 comprises an array of individual detectors positioned to detect the spring element 137, 147 at different positions in the length direction of the spring element 137, 147. The spring force of the spring element 137, 147 is determined by the spring constant and the spring length (specifically by the spring stretching). The length of the spring element 137, 147 as determined by the spring sensors 138, 148 thus provides an accurate measure for the spring force, which in turn determines the tension in the web 8.

In the embodiment in FIG. 2 separate actuators 135B and springs elements 137 are provided for controlling the spring force on either side of the dancer 131. As such different forces can applied to the different ends of the dancer 131. This allows the dancer suspension assembly 130, 140 to compensate for tension variations in the width directions of the web 133. Alternatively, the tension force may be kept similar at both ends of the dancer 131 by the embodiment shown in FIG. 3.

FIG. 3 shows another embodiment of a dancer suspension assembly 230 according to the present invention. The dancer 231 is rotatably connected at both lateral ends to the wire element 233. The wire element 233 runs via the pulley assembly 235 from one lateral side of the dancer 231 to the other side of the dancer 231. From the sides of the dancer 231 the wire element 233 extends upwards to the support pulleys 235A, 235G.

The support pulleys 235A, 235B are spaced from one another in the width direction W by at least the width of the dancer 231. The dancer 231 under the influence of gravity is suspended from the dancer support pulleys 235A, 235G. The dancer support pulleys 235A, 235G are preferably positioned vertically above and over the respective sides of the dancer 231. The wire element 233 is directed by the dancer support pulleys 235A, 235G from its vertical orientation towards the horizontal width direction W. It will be appreciated that different directions may be applied within the scope of the present invention. From the dancer support pulleys 235A, 235G the wire element 233 extends towards the spring support pulleys 235C, 235D.

The dancer suspension assembly 230 in FIG. 3 comprises a spring assembly 237 comprising at least two spring elements 237A, 237B. The spring elements 237A, 237B are positioned respectively between the dancer support pulley 235A, 235G and the spring support pulleys 235C, 235D. The spring element 237A, 237B is able to stretch and contract between the dancer support pulley 235A, 235G and the spring support pulleys 235C, 235D. By adjusting the length L1 of the spring element 237A, 237B the tension in the wire element 233 can be controlled. The tension in the wire element 233 acts opposite to the forces of gravity acting on the dancer 231. Thereby the force exerted by the dancer 231 on the web 8 can be controlled. In consequence the tension in the web 8 can be controlled by adjusting the spring length L1 of the spring elements 237A, 237B. In the vertical downward direction the force of gravity F_{G} acts on the dancer 231 while the tension force F_{T} in the web and the spring force F_{S} act on the dancer 231 in the vertically upwards direction V. The sum of the spring force F_{S} and the tension force F_{T} in the vertical direction V is equal but opposite to the force of gravity F_{G}. This balance of forces allows for the ration between the tension force F_{T} and the spring force F_{S} to be varied. For example, when more tension in the web 8 is desired, the spring force F_{S} can be reduced by contracting the spring elements 137A, 237B. The dancer 231 then presses more heavily on the web 8, thereby increasing the tension in the web 8.

The spring force or length L1 is controlled via the actuator 235B. The actuator 235B is configured to move the central pulley 235F. The wire element 233 runs around the central pulley 235F such that each portion of the wire element 233 extending on either side of the central pulley 235F comprises a spring element 237A, 237B. In a preferred embodiment, the pulley assembly 235 is preferably configured such that the spring elements 237A, 237B extend in the same direction. Said direction is preferably parallel to the direction of movement defined by the actuator 235B. Thereto further pulleys 235E may be provided. In this manner a displacement L2 of the central pulley 235F as controlled by the actuator 235B results in a length adjustment L1 of both of the spring elements 237A, 237B. The length adjustment L1 of the spring elements 237A, 237B is preferably half that of the displacement of the central pulley 235F. Only a single actuator is required to adjust the tension in both spring elements 237A, 237B.

To accurately set the spring length L1 a spring sensor assembly 238 is provided. The spring sensor assembly 238 comprises a plurality of position sensors 238A-D configured to detect the position of the central pulley 235F at various positions along its movement range. In the basic embodiment shown in FIG. 3 the home position sensor 238C determines whether or not the central pulley 235F is positioned at a predetermined starting position or in a predetermined starting position range. Depending on the requirements of the print job, the position of the central pulley 235F may vary during operation. For example, the printing system 100 allows for printing on both the inner side as well as on the outer side of the web media wound up on the input roller R1. For inner side printing the dancer 231 is positioned at a different position B than for outer side printing (position A). For either position A, B or print mode a respective limit sensor 238A, 238B has been provided. For outer side printing with the dancer 231 in position A, the limit sensor 238B detects whether the central pulley 235F moves a beyond predetermined distance from the home position, such that the spring force of the spring element 237A, 237B decreases below a tension level wherein tension in the web 8 is insufficient for accurately controlling the media stepping. Similarly, a further limit sensor 238A is provided for the inner side printing mode.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A web printing system, comprising:
a dancer positioned along a transport path extending from an input roller for holding a first media roll to an output roller for holding a second media roll;
an actuator for moving the dancer with respect to a frame of the printing system, wherein the dancer is connected to the actuator via a spring element.

2. The web printing system according to claim 1, wherein the actuator is configured for adjusting a length of the spring element, thereby determining a spring force and a tension in a web in contact with the dancer.

3. The web printing system according claim 2, further comprising a spring force sensor for determining a spring force generated by the spring element.

4. The web printing system according to claim 3, wherein the spring force sensor comprises a spring length sensor.

5. The web printing system according to claim 1, wherein the dancer is connected to the spring element via a flexible wire element.

6. The web printing system according to claim 5, further comprising a pulley assembly, wherein the wire element extends substantially perpendicular to a length of the dancer away from the dancer and curves around the pulley assembly towards the actuator.

7. The web printing system according to claim 5, wherein the wire element extends from a first to a second side of the dancer via the pulley assembly.

8. The web printing system according to claim 6, wherein the actuator connects to an actuator pulley of the pulley assembly, which actuator pulley is moveable with respect to the frame to adjust the spring force.

9. The web printing system according to claim 1, wherein when viewed from above the pulley assembly is positioned between the input roller and the output roller.

10. The web printing system according to claim 1, further comprising a controller storing a media catalogue comprising a plurality of spring force settings for a plurality of media types, wherein the controller is configured to control the actuator to set a spring force of the spring element to the spring force setting in accordance with a media type selected from the media catalogue.

11. A dancer suspension assembly for use in the printing system according to claim 1, comprising:
a wire element connectable to a dancer of the printing system, which wire element is connected to actuator via a spring element, which actuator is configured to control a spring force exerted by the spring element on the wire element; and
a pulley assembly around which the wire element runs.

12. The dancer suspension assembly according to claim 11, wherein the spring element extends between two pulleys of the pulley assembly.

13. A method for transport a web in the web printing system according to claim 1, the method comprising the steps of:
a dancer pressing against the web to tension the web, wherein a spring element pulls on the dancer via a wire element; and
an actuator pulling on the spring element for controlling a spring force exerted by the spring element on the dancer.

14. The method according to claim 13, further comprising the step of:
a roller actuator for rotating a roller adjusting the position of the dancer to an angle over which angle the web curves around the dancer substantially constant as the web is unwound from a media roll on the input roller.

15. The method according to claim 14, further comprising the step of sensing the spring force by means of a spring force sensor.
